(19) United States
(12) Patent Application Publication
(10) Pub. No.: US 2006/0130048 A1
(43) Pub. Date: Jun. 15, 2006

(54) Shared schema for software user interface designers and developers

(75) Inventors: Yuan Der Ho, San Mateo, CA (US); Jamie Hoover, Campbell, CA (US); Edward Maesen, San Francisco, CA (US); James Reffell, Mountain View, CA (US)

Correspondence Address: SCHWEGMAN, LUNDBERG, WOESSNER & KLUTH, 121 S. 8TH STREET, SUITE 1600, MINNEAPOLIS, MN, 55402, US

(73) Assignee: eBay Inc.

(21) Appl. No.: 11/253,511

(22) Filed: Oct. 19, 2005

Related U.S. Application Data
(60) Provisional application No. 60/635,854, filed on Dec. 13, 2004.

(51) Int. Cl. G06F 9/44

(52) U.S. Cl. 717/170

(57) ABSTRACT

A method, an apparatus and a system provide a shared schema for software user interface designers and developers. In some embodiments, a system includes a machine-readable medium to store a set of validation rules that are based on rules derived from a designer and rules derived from a developer. The system also includes a validation logic to validate software code from the designer, wherein the validation logic is to validate a version of the software code modified by the developer.

### RELATED APPLICATION

This application claims the priority benefit of U.S. Provisional Application No. 60/635,854, filed Dec. 13, 2004, which is incorporated herein by reference.

### TECHNICAL FIELD

The application relates generally to data processing, and, more particularly, to a shared schema for software user interface designers and developers.

### BACKGROUND

Creation of software is a multi-step process. The multi-step process typically includes design, development and testing. With regard to user-interface software, the designers typically generate a written specification that includes a number of pictures that are to be the different user-interface screens. Based on the written specification, the developers then generate the actual code (e.g., Extensible Markup Language (XML), Hypertext Markup Language (HTML), etc.) that represents these screens. These user-interface screens are then manually reviewed by a number of people to ensure that these screens represent the written specification. If these screens do not correctly match the written specification, the developers modify the code. This process is repeated until the screens correctly match the written specification.

Moreover, large, complex websites often face unique design and development challenges. These can include poor usability due to widespread design inconsistencies, failure to follow design guidelines and development best practices, and development inefficiencies caused by the difficulties of communicating across disparate teams.

Large websites are often created by multiple design and development teams, who may belong to different parts of the organization, and may work in globally distributed offices. Nonetheless, these teams are expected to create web pages that have a consistent interface. In practice, multiple inconsistencies creep into such sites, causing usability and branding issues. These inconsistencies may be relatively minor (such as those having to do with fonts, colors, spacing, and alignment) or more significant (such as inconsistent or unpredictable placement of major interface elements). In addition, disparate teams may develop innovative and effective interfaces for one area of a site, but fail to communicate its value to other teams.

### SUMMARY

According to some embodiments, methods, systems and apparatus provide a schema for software user interface designers and developers. In some embodiments, a system includes a machine-readable medium to store a set of validation rules that are based on rules derived from a designer and rules derived from a developer. The system also includes a validation logic to validate software code from the designer, wherein the validation logic is to validate a version of the software code modified by the developer.

In some embodiments, a method includes receiving software code for a user interface, wherein the software code is generated by a software user interface designer. The method also includes receiving a schema that includes one or more rules confirmed by the software user interface designer and a software developer. The method includes validating the software code for the user interface based on the schema. Additionally, the method includes receiving a modified version of the software code that is the software code that has been modified by the software developer. The method includes validating the modified version of the software code based on the schema.

In some embodiments, a method includes receiving software generated by a software user interface designer of a number of software user interface designers, wherein the number of software user interface designers are designing software for a number of software projects that are essentially independent. The method also includes validating the software based on at least one rule agreed upon by the number of software user interface designers and a number software developers, wherein the number of software user interface designers are developing software for the number of software projects.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1A illustrates a system that provides for joint development of a shared schema and Extensible Stylesheet Language (XSL) code by software user interface designers and developers, according to some embodiments of the invention.

FIG. 1B illustrates a system that uses a shared schema for software user interface designers and developers, according to some embodiments of the invention.

FIG. 2 illustrates a computer device that executes software for performing operations related to a schema for software user interface designers and developers, according to some embodiments of the invention.

FIG. 3 illustrates a flow diagram of operations related to generating a schema shared among software user interface designers and developers, according to some embodiments of the invention.

FIG. 4 illustrates a flow diagram of operations related to using a schema for software user interface designers and developers, according to some embodiments of the invention.

FIGS. 5A-5B illustrate exemplary software code for a user interface that is generated by a software developer, according to some embodiments of the invention.

FIG. 6 illustrates exemplary validation rules, according to some embodiments of the invention.

FIG. 7 illustrates a version of the software code for a user interface of FIG. 5A that is modified by a software developer, according to some embodiments of the invention.

FIG. 8 illustrates HTML code generated from the XSL code of FIG. 7, according to some embodiments of the invention.

### DETAILED DESCRIPTION

Methods, systems and apparatus for providing a schema for software user interface designers and developers are described. In the following description, numerous specific details are set forth. However, it is understood that embodiments of the invention may be practiced without these specific details. In other instances, well-known circuits, structures and techniques have not been shown in detail in order not to obscure the understanding of this description. Additionally, in this description, the phrase “exemplary embodiment” means that the embodiment being referred to serves as an example or illustration.

Some embodiments provide a schema used by both software user interface designers and developers. This schema may be shared by both the designers and developers of software. In some embodiments, the schema is a rule set that is used to validate code generated by the designers and the developers. Moreover, the validated code from the designers may be used by the developers. In some embodiments, the software may be for creation of user-interface screens, such as different types of Graphical User Interfaces (GUIs). In some embodiments, the rule set may include rules related to locations, sizes, colors, etc. of different components of the user-interface screens. For example, a rule may require that a particular type of button only be in certain locations relative to another component. Another rule may require that a user input screen, menu, etc. be a certain size, color, etc. Therefore, the look and feel of user interface screens may be uniform across different design and development groups in a given business entity or corporate organization. Also, the basic structure and hierarchy of user interface screens may be consistent, while allowing visual details to vary.

Therefore, some embodiments address the challenge of communicating and enforcing design and development standards across multiple organizations. These challenges may result in poor usability because of widespread design inconsistencies and development inefficiencies. Some embodiments use a small cross-functional team that creates a shared design and development language. This language may embody the organization's standards through markup tags that refer to interaction components. The language may represent an interaction layer separate from business logic and visual treatment and may be used both by designers to communicate requirements and by developers to create live pages. Designers and developers following this methodology may create consistent web interfaces more efficiently.

Creating a shared language for both developers and designers to use may ensure that designs are communicated accurately from one group to the other. By literally using the same code, designers may be saved from having to specify, in text or print, interface details like fonts, colors, and spacing, and developers may be saved from attempting to interpret invalid code or pictures. In addition, because the language may be developed in collaboration between designers and developers ensures that the language serves both groups equally, rather than being optimized for one or the other. The two groups may also be forced to negotiate and agree on any potential issues (such as how to best degrade designs for certain browsers) ahead of time, rather than late in a project. These mutually negotiated agreements may have a better chance of lasting for reuse.

By embodying interaction standards for an organization in this language, designers are able to explore their design creatively while staying within the standards. In addition, as standards change, components may be updated, thereby propagating changes globally with little additional effort.

While described with reference to software code related to a user interface, embodiments are not so limited. For example, the software code may relate to business software, database design, software that is part of different types of communications, etc.

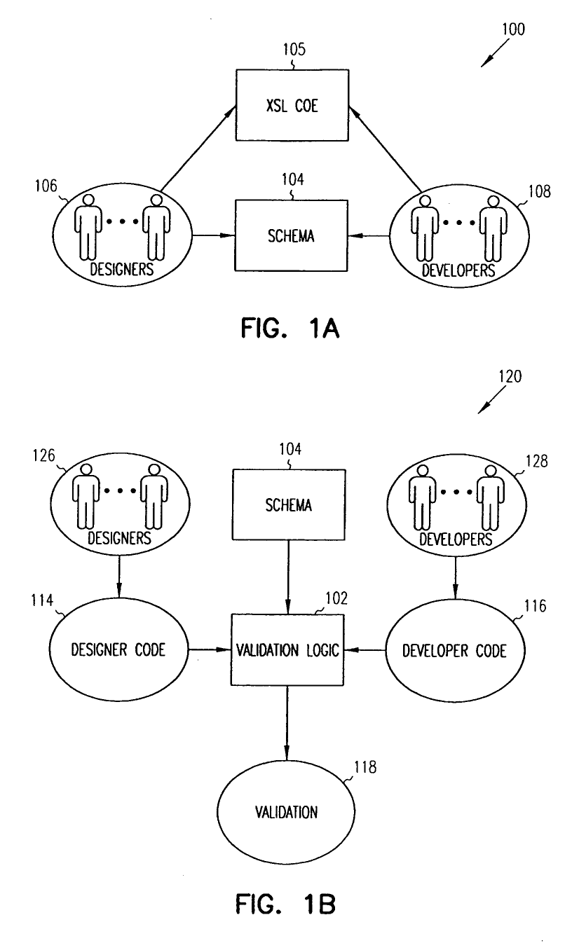

FIG. 1A illustrates a system that provides for joint development of a shared schema and Extensible Stylesheet Language (XSL) code by software user interface designers and developers, according to some embodiments of the invention. In particular, FIG. 1 illustrates a system 100 that includes a schema 104, XSL code 105, designers 106 and developers 108.

The designers 106 may be representative of one to a number of software designers that design software, such as different user interfaces (e.g., Graphical User Interfaces (GUIs)). The developers 108 may be representative of one to a number of software developers that develop software based on the design provided by the designers 106. In some embodiments, the designers 106 and the developers 108 may be designing and developing software across multiple, essentially independent projects within a same business entity. Alternatively, the designers 106 and the developers 108 may be designing and developing for a same project and/or across multiple business entities.

As shown, the designers 106 and the developers 108 both provide input into the creation of the schema 104 and the XSL code 105. In particular, the schema 104 may establish certain criteria that the designers' software and the developers' software are to meet in order to be validated. For example, if the designers 106 and the developers 108 are part of a same business entity and are designing and developing GUI software across multiple projects, the schema 104 may ensure that the look-and-feel of the GUIs are the same. In particular, attributes of certain components are limited or defined relative to other components. For example, the background of certain interface screens is a given color. The menus may be required to in a certain location on the screens. The buttons may be required to certain sizes, colors, in certain locations, etc. Certain text may be required to be a given size, color, font, etc. In some embodiments, a trademark may be required to be located in a given location on each screen. As further described below, the XSL code 105 may be used to transform XML code (generated by the software designers and/or software developers) into HTML code.

FIG. 1B illustrates a system that uses a shared schema for software user interface designers and developers, according to some embodiments of the invention. In particular, FIG. 1B illustrates a system 120 that includes a validation logic 102, the schema 104, designers 126 and developers 128. The validation logic 102 may be software, hardware, firmware or a combination thereof. An example of the validation logic 102 as software executing on a processor is set forth below.

Similar to the designers 106, the designers 126 may be representative of one to a number of software designers that design software, such as different user interfaces (e.g., Graphical User Interfaces (GUIs)). Similar to the developers 108, the developers 128 may be representative of one to a number of software developers that develop software based on the design provided by the designers 126. In some embodiments, the designers 126 and the developers 128 may be designing and developing software across multiple, essentially independent projects within a same business entity. Alternatively, the designers 126 and the developers 128 may be designing and developing for a same project and/or across multiple business entities.

Referring to FIG. 1A, the designers 126 may be the same set of persons as the designers 106. The designers 126 may be a subset of persons as the designers 106. In some embodiments, the designers 126 may be different from the designers 106. Similarly, the developers 128 may be the same set of persons as the developers 108. The developers 128 may be a subset of persons as the developers 108. In some embodiments, the developers 128 may be different from the developers 108.

Therefore, as shown, the designers 126 develop software (designer code 114) that is validated by the validation logic 102 based on the schema 104. Moreover, the developers 128 develop software (developer code 116) that is also validated by the validation logic 102 based on the schema 104. In some embodiments, once validated, the designer code 114 is used by the developers 128 to develop the developer code 116. In other words, the developer code. 116 is a modified version of the designer code 114. Accordingly, in contrast to conventional design and development environments, the developers may leverage the code already developed by the designers. The designer code 114 and the developer code 116 may be any type of software code, including XML.

As shown, the validation logic 102 may validate the designer code 114 and the developer code 116 to output the result of the validation 118. In some embodiments, the validation logic 102 may output a message that includes success or failure. For example, the validation logic 102 may output errors if the designer code 114 or the developer code 116 are not in compliance with the schema 104. In some embodiments, the validation logic 102 may be incorporated into the editor that is being used to enter the designer code 114 and the developer code 116. Accordingly, each time the designer code 114 and the developer code 116 are saved in the editor, the validation logic 102 performs the validation. Alternatively or in addition, the editor may include an option to validate which causes the execution of the validation logic 102.

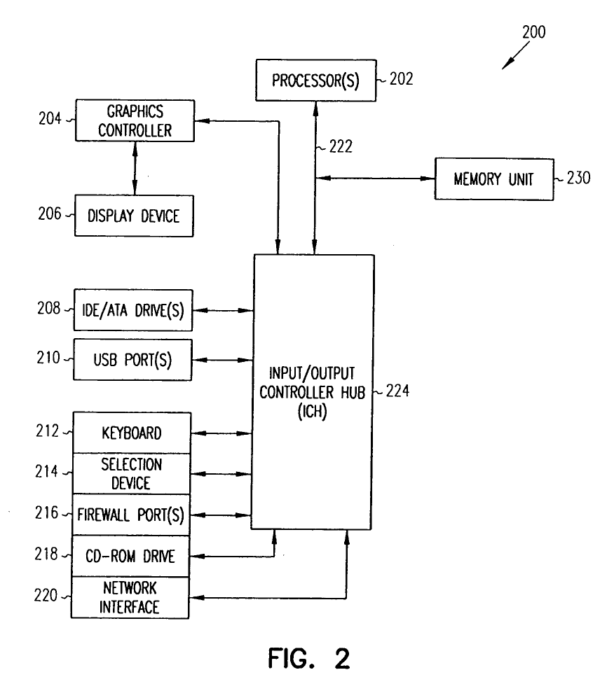

Some embodiments wherein software performs operations related to providing an interface between software user interface designers and developers as described herein are now described. In particular, FIG. 2 illustrates a computer device that executes software for performing operations related to a schema for software user interface designers and developers, according to some embodiments of the invention.

As illustrated in FIG. 2, the computer system 200 comprises processor(s) 202. The computer system 200 also includes a memory unit 230, processor bus 222, and Input/Output controller hub (ICH) 224. The processor(s) 202, the memory unit 230, and the ICH 224 are coupled to the processor bus 222. The processor(s) 202 may comprise any suitable processor architecture. The computer system 200 may comprise one, two, three, or more processors, any of which may execute a set of instructions in accordance with embodiments of the invention.

The memory unit 230 may store data and/or instructions, and may comprise any suitable memory, such as a random access memory (DRAM). For example, the memory 230 may be a Synchronous RAM (SRAM), a Synchronous Dynamic RAM (SDRAM), DRAM, a double data rate (DDR) Synchronous Dynamic RAM (SDRAM), etc. The computer system 200 also includes IDE drive(s) 208 and/or other suitable storage devices. A graphics controller 204 controls the display of information on a display device 206, according to some embodiments of the invention.

The input/output controller hub (ICH) 224 provides an interface to I/O devices or peripheral components for the computer system 200. The ICH 224 may comprise any suitable interface controller to provide for any suitable communication link to the processor(s) 202, memory unit 230 and/or to any suitable device or component in communication with the ICH 224. For one embodiment of the invention, the ICH 224 provides suitable arbitration and buffering for each interface.

For some embodiments of the invention, the ICH 224 provides an interface to one or more suitable integrated drive electronics (IDE) drives 208, such as a hard disk drive (HDD) or compact disc read only memory (CD ROM) drive, or to suitable universal serial bus (USB) devices through one or more USB ports 210. For one embodiment, the ICH 224 also provides an interface to a keyboard 212, mouse 214, CD-ROM drive 218, or other suitable devices through one or more firewire ports 216. In some embodiments, the ICH 224 also provides a network interface 220 though which the computer system 200 can communicate with other computers and/or devices. The ICH 224 is connected to a wireless interface, which enables the computer system 200 to wirelessly connect to computing devices using any suitable wireless communication protocol (e.g., 802.11b, 802.11g, etc.).

In some embodiments, the computer system 200 includes a machine-readable medium that stores a set of instructions (e.g., software) embodying any one, or all, of the methodologies described herein. Furthermore, software can reside, completely or at least partially, within memory unit 230 and/or within the processor(s) 202.

With reference to FIG. 1, the memory 230 and/or one of the IDE/ATA drives 208 may store the validation logic 102, the schema 104, the designer code 114 and the developer code 116. In some embodiments, the validation logic 102, the designer code 114 and the developer code 116 may be instructions executing within the processor(s) 202. Therefore, the validation logic 102, the schema 104, the designer code 114 and the developer code 116 may be stored in a machine-readable medium that are a set of instructions (e.g., software). For example, the validation logic 102, the designer code 114 and the developer code 116 may reside, completely or at least partially, within the memory 230, the processor(s) 202, one of the IDE/ATA drive(s) 208, etc.

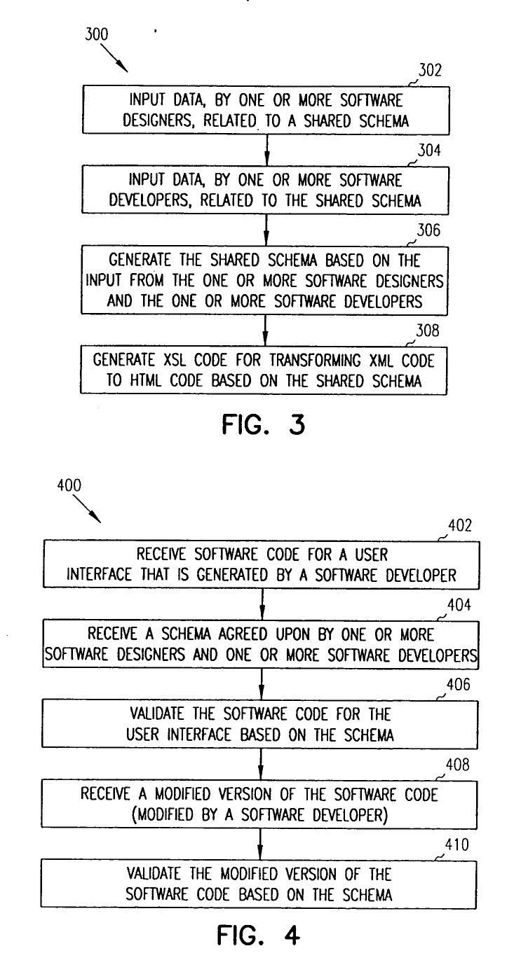

The operations of generating a schema shared between software user interface designers and developers are now described. In particular, FIG. 3 illustrates a flow diagram of operations related to generating a schema shared among software user interface designers and developers, according to some embodiments of the invention. The flow diagram 300 is described in reference to FIG. 1A. The flow diagram 300 commences at block 302.

At block 302, one of more of the software designers 106 input data related to the shared schema 104. The data may be different standards or rules that are used as part of the schema 104. The rules may be related to the look-and-feel of different user interface screens. For example, certain buttons may only be located in certain location relative to other components (such as menus, input screens, etc.) on the screens. The software designers 106 may input data related to rules on the screen sizes, locations and colors, of buttons, menus, etc. The flow continues at block 304.

At block 304, one or more of the software developers 108 also input data related to the shared schema 104. Similar to the data from the software designers 106, the data may be different standards or rules that are used as part of the schema 104 (as described above). The flow continues at block 306.

At block 306, the shared schema is generated based on the input from the one or more the designers 106 and the one or more developers 108. The designers 106 and the developers 108 agree upon a set of rules that form the shared schema 104. The schema 104 may, therefore, be a compromise among the designers 106 and the developers 108. The flow continues at block 308.

At block 308, XSL code is generated, which may be used for transforming XML code to HTML code based on the shared schema. The shared schema 104 may then be used by designers and developers to verify that their code is in compliance with the rules therein. Further, the designers and developers may use the XSL code 105 to transform the XML code to HTML code.

In particular, the operations of using an interface for performing operations related to a schema for software user interface designers and developers are now described. In particular, FIG. 4 illustrates a flow diagram of operations related to using a schema for software user interface designers and developers, according to some embodiments of the invention. The flow diagram 400 is described in reference to FIG. 1B. The flow diagram 400 commences at block 402.

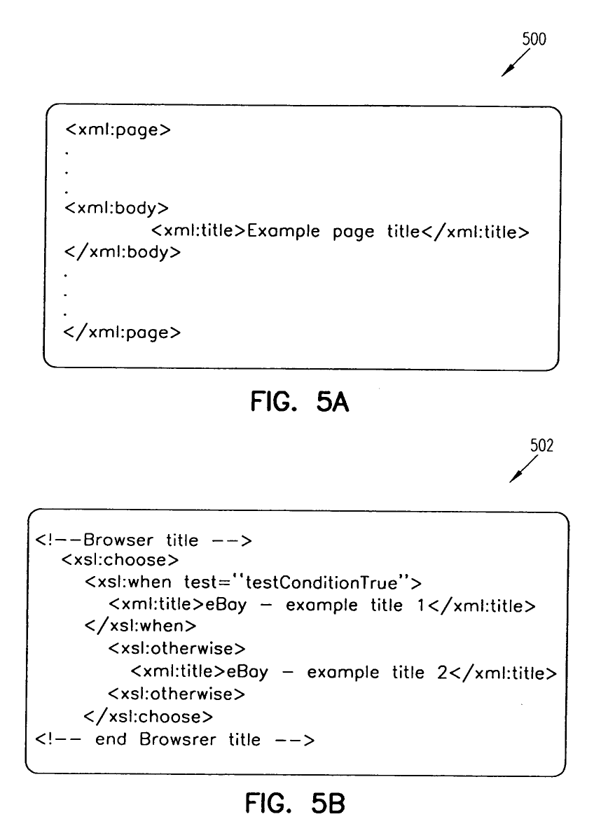

At block 402, the validation logic 102 receives software code for a user interface that is generated by a software developer. FIGS. 5A-5B illustrate exemplary software code for a user interface that is generated by a software developer, according to some embodiments of the invention. In particular, FIG. 5A-5B illustrate XML code 500 and XML code 502, respectively, that may be representative of the designer code 114 (shown in FIG. 1B). The flow continues at block 404.

At block 404, the validation logic 102 receives a schema (validation rules) confirmed or agreed upon by one or more software user interface designers and one or more software developers. Referring to FIG. 1, the schema 104 are confirmed and agreed upon by the designers 106 and the developers 108. Examples of the schema 104 may include rules for the look-and-feel of different user interface screens. For example, certain buttons may only be located in certain location relative to other components (such as menus, input screens, etc.) on the screens. The schema 104 may includes rules on the screen sizes, locations and colors, of buttons, menus, etc.

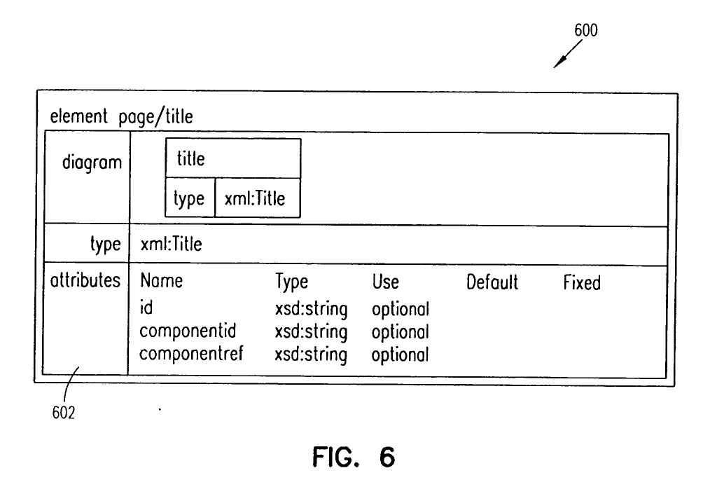

FIG. 6 illustrates exemplary validation rules, according to some embodiments of the invention. In particular, FIG. 6 illustrates validation rules 600 that may be representative of the schema 104 (shown in FIGS. 1A-1B). The validation rules 600 may be rules for validating the XML code 500 (shown in FIG. 5A) for generating a title page for a user interface. The validation rules 600 including a number of attributes 602 for the title page. For example, the number of attributes includes rules that the attributes, the “id”, the “componentid” and the “componentRef”, be of the type is “xsd:string” and are optional.

In some embodiments, the schema 104 may be confirmed or agreed upon by software user interface designers and software developers across different, essentially independent software projects. Such software user interface designers and software developers may be designing and developing for different, essentially independent software projects in a same business entity or corporate organization. Therefore, as described, the user interface across an entire business entity or corporate organization may have the same look-and-feel. Alternatively, the schema 104 may be confirmed or agreed upon by software user interface designers and software developers in a same software project. The flow continues at block 406.

At block 406, the validation logic 102 validates the software code for the user interface based on the schema (validation rules). In some embodiments, the validation logic 102 may perform this validation each time the software code is saved by the software user interface designer, after a button is selected, etc. As described above, the validation may validate location, sizes, colors, etc. for different components on the user interface screens. In some embodiments, the validation logic 102 may output a log file based on the validation that indicates whether the software code was successfully validated. The validation logic 102 may output errors into the log file if the validation was not successful. Therefore, the software user interface designer may update the software code and re-execute this validation until the validation is successful. The flow continues at block 408.

At block 408, the validation logic 102 receives a modified version of the software code that is the software code from the software user interface designer that has been modified by one of the software developers. In particular, after the software code has been validated successfully for the software user interface designer based on the validation rules, the software code may be provided to the associated software developer. The associated software developer may then use this software code and performs updates thereto. Therefore, as described, software developers may leverage that developed validated software code from the software user interface designers. The software developers are not required to developed software code based on screenshots, pictures, etc. Rather, the software developers may modify the software code already generated by the software user interface designers.

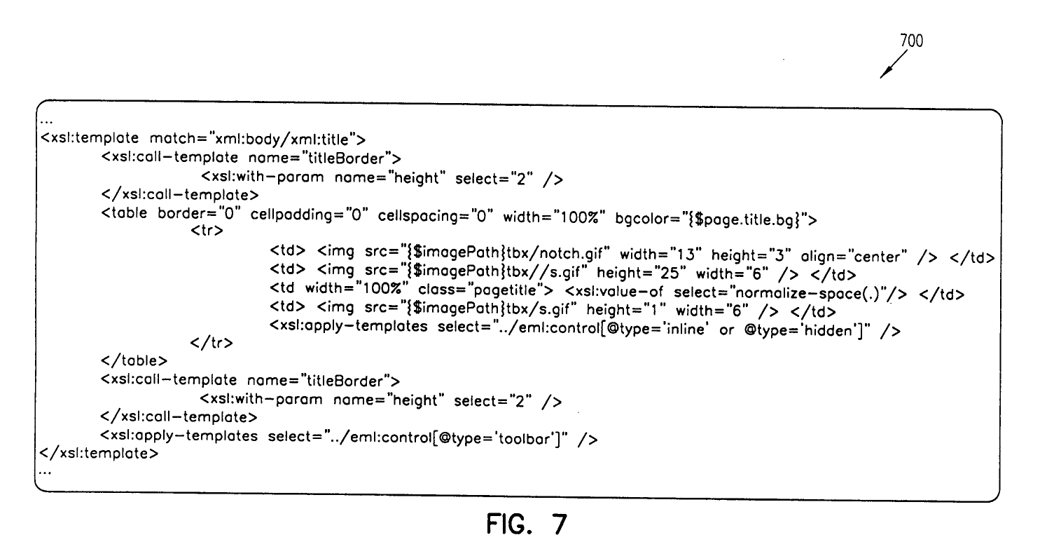

The software developer may use the XML code in the development of their developer code. For example, the software developer may incorporate different parts of the XML code into their own development code, incorporate the entire XML code into their own development code, etc. FIG. 7 illustrates a version of the software code for a user interface of FIG. 5A that is modified by a software developer, according to some embodiments of the invention. In particular, FIG. 7 illustrates Extensible Stylesheet Language (XSL) code 700 that may be representative of the developer code 116 (shown in FIG. 1B). The software developer may receive the validated designer code from the software user interface designer. For example, the software developer may receive the XML code 500 (shown in FIG. 5A) after its validation. The flow continues at block 410.

At block 410, the validation logic 102 validates the modified version of the software code based on the schema (validation rules). In some embodiments, the validation logic 102 may perform this validation each time the software code is saved by the software developer, after a button is selected, etc. As described above, the validation may validate location, sizes, colors, etc. for different components on the user interface screens. In some embodiments, the validation logic 102 may output a log file based on the validation that indicates whether the software code was successfully validated. The validation logic 102 may output errors into the log file if the validation was not successful. Therefore, the software developer may update the software code and re-execute this validation until the validation is successful.

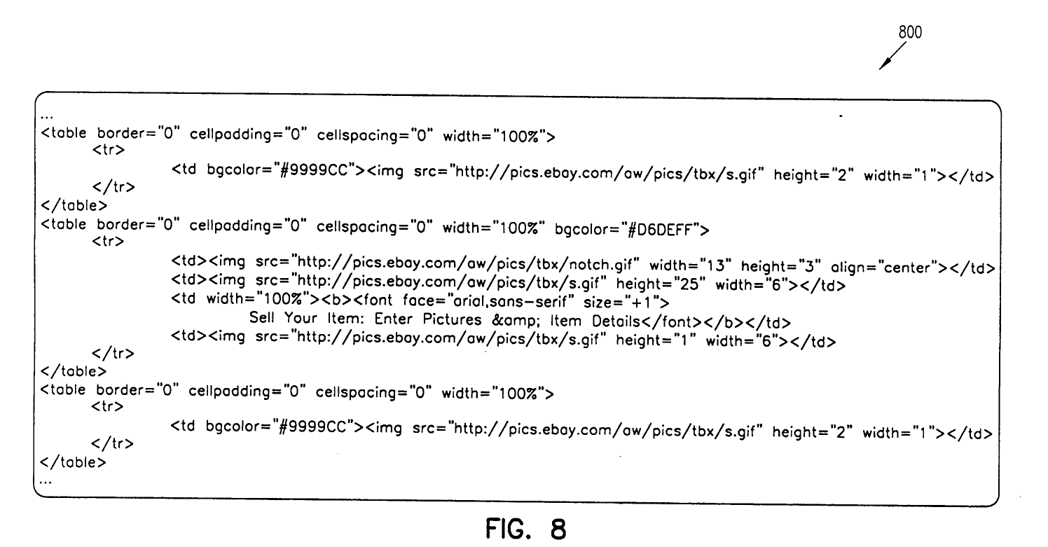

After validation, the software developer may convert the modified version of the software code to a different type of code. For example, if the modified version of the software code is XSL code, the software developer may convert the XSL code to HTML code, using any of a number of software converters. The HTML code may be then used for display of a GUI, etc. FIG. 8 illustrates HTML code generated from the XSL code of FIG. 7, according to some embodiments of the invention. In particular, FIG. 8 illustrates HTML code 800 that may be used to display a title page that was originally defined by a designer using XML code (shown in FIG. 5A). Accordingly, some embodiments may provide for a common schema shared by software user interface designers and developers to ensure that the GUIs generated by the developers are those designed by the designers. Moreover, some embodiments allow the software developers to use the code generated by the designers in the development of code.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for a schema for software user interface designers and developers, in accordance with some embodiments of the invention. A flow diagram illustrates the operations for a schema for software user interface designers and developers, in accordance with some embodiments of the invention. The operations of the flow diagram are described with references to the systems/apparatus shown in the block diagrams. However, it should be understood that the operations of the flow diagram could be performed by embodiments of systems and apparatus other than those discussed with reference to the block diagrams, and embodiments discussed with reference to the systems/apparatus could perform operations different than those discussed with reference to the flow diagram.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. A system including:
a machine-readable medium to store a set of validation rules that are based on rules derived from a designer and rules derived from a developer; and
a validation logic to validate software code from the designer, wherein the validation logic is to validate a version of the software code modified by the developer.

2. The system of claim 1, wherein the software code is for a Graphical User Interface.

3. The system of claim 1, wherein rules derived from the designer include a rule that limits a size, a location, or a color of a component of a Graphical User Interface (GUI).

4. The system of claim 3, wherein the component of the GUI includes a button, a menu or text.

5. The system of claim 3, wherein the rule that limits the size, the location or the color includes a rule that limits the size to a range of sizes.

6. The system of claim 3, wherein the rule that limits the size, the location or the color includes a rule that limits the location to less than all but more than one location relative to a number of other components of the GUI.

7. The system of claim 1, wherein the validation logic is to validate software code from designers across multiple and essentially independent software projects of a business entity.

8. The system of claim 1, wherein the validation logic is to validate software code from developers across multiple and essentially independent software projects of a business entity.

9. A method including:
receiving software code for a user interface, the software code generated by a software user interface designer;
receiving a schema that includes one or more rules confirmed by the software user interface designer and a software developer;
validating the software code for the user interface based on the schema;
receiving a modified version of the software code that is the software code that has been modified by the software developer; and
validating the modified version of the software code based on the schema.

10. The method of claim 9, wherein the schema includes a rule that limits an attribute of a component of the user interface.

11. The method of claim 10, wherein the attribute includes a size, a location, or a color.

12. The method of claim 11, wherein the component includes a button, a menu or text on the user interface.

13. The method of claim 11, wherein the rule that limits the attribute of the component includes a rule that limits the size of the component to a range of sizes.

14. The method of claim 11, wherein the rule that limits the attribute of the component includes a rule that limits the color of the component to less than all but more than one color.

15. The method of claim 9, further including validating software code for user interfaces, based on the schema, from multiple software user interface designers across multiple and essentially independent software projects of a business entity.

16. The method of claim 15, further including validating modified versions of the software code, based on the schema, from software developers across multiple and essentially independent software projects of a business entity.

17. A method including:
receiving software generated by a software user interface designer of a number of software user interface designers, wherein the number of software user interface designers are designing software for a number of software projects that are essentially independent; and
validating the software based on at least one rule agreed upon by the number of software user interface designers and a number software developers, wherein the number of software user interface designers are developing software for the number of software projects.

18. The method of claim 17, further including:
receiving an updated version of the software that has been updated by one of the number of software developers; and
validating the updated version of the software based on the at least one rule.

19. The method of claim 17, wherein receiving the software includes receiving software for a Graphical User Interface.

20. The method of claim 17, wherein the at least one rule includes a rule that limits an attribute of a component of a Graphical User Interface screen.

21. The method of claim 20, wherein the attribute includes a size, a location, or a color.

22. The method of claim 21, wherein the component includes a button, a menu or text on the Graphical User Interface screen.

23. A machine-readable medium that provides instructions which, when executed by a machine, cause said machine to perform operations of claim 9.

24. A machine-readable medium that provides instructions which, when executed by a machine, cause said machine to perform operations of claim 17.
